(19) United States
(12) Patent Application Publication
(10) Pub. No.: US 2025/0030469 A1
(43) Pub. Date: Jan. 23, 2025

(54) TIME-DOMAIN COMPRESSION CONSIDERATIONS FOR ACCUMULATED CHANNEL STATE INFORMATION REPORTS

(71) Applicant: QUALCOMM Incorporated, San Diego, CA (US)

(72) Inventors: Ahmed ELSHAFIE, San Diego, CA (US); Runxin WANG, San Diego, CA (US); Yu ZHANG, San Diego, CA (US); Hwan Joon KWON, San Diego, CA (US)

(21) Appl. No.: 18/708,449

(22) PCT Filed: Jan. 10, 2022
(86) PCT No.: PCT/CN2022/070937

§ 371 Date: May 8, 2024

(51) Int. Cl. H04B 7/06; H04W 72/1273

(52) U.S. Cl. CPC H04B 7/0626; H04W 72/1273

(57) ABSTRACT

Methods, systems, and devices for wireless communication are described. A user equipment (UE) may receive a plurality of downlink transmissions from a base station. The UE may identify a channel state information (CSI) trigger event. The UE may transmit an accumulated CSI report comprising CSI for each downlink transmission of the plurality of downlink transmissions in accordance with the CSI trigger event, wherein a quantization level of the CSI for each downlink transmission in the accumulated CSI report is based at least in part on a time between the downlink transmission and the CSI trigger event.

### CROSS REFERENCE

The present Application is a 371 national phase filing of International PCT Application No. PCT/CN2022/070937 by ELSHAFIE et al., entitled “TIME-DOMAIN COMPRESSION CONSIDERATIONS FOR ACCUMULATED CHANNEL STATE INFORMATION REPORTS,” filed Jan. 10, 2022, which is assigned to the assignee hereof, and which is expressly incorporated by reference in its entirety herein.

### FIELD OF TECHNOLOGY

The following relates to wireless communication, including time-domain compression considerations for accumulated channel state information reports.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support time-domain compression considerations for accumulated channel state information (CSI) reports. Generally, the described techniques provide for using quantization levels for some or all of the CSI reports within an accumulated CSI report to reduce the number of bits used to communicate the accumulated CSI report. For example, the user equipment (UE) may receive a plurality of downlink transmissions from a base station. This may include channel state information-reference signal (CSI-RS) transmissions, physical downlink shared channel (PDSCH) transmissions, and the like, from the base station. The UE may identify or otherwise determine a CSI trigger event (e.g., an event initiating transmission of the accumulated CSI report). The UE may transmit or otherwise provide the accumulated CSI report to the base station in response to the CSI trigger event. The accumulated CSI report may use quantization levels of the CSI for each downlink transmission (e.g., for each CSI report of a downlink transmission in the accumulated CSI report). In some examples, the quantization levels may be based on the timing of the downlink transmission and the CSI trigger event. For example, the level of quantization level for the oldest CSI may be higher (e.g., use fewer bits) than more recent CSI. In some examples, the quantization level used for each CSI may include using fewer bits for the older CSI, using differential CSI values for some CSI relative to a reference CSI, and the like. Accordingly, the UE may transmit or otherwise provide the accumulated CSI report to the base station using fewer bits based on quantization levels.

A method for wireless communication at a UE is described. The method may include receiving a set of multiple downlink transmissions from a base station, identifying a CSI trigger event, and transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

An apparatus for wireless communication at a UE is described. The apparatus may include a processor, memory coupled with the processor, and instructions stored in the memory. The instructions may be executable by the processor to cause the apparatus to receive a set of multiple downlink transmissions from a base station, identify a CSI trigger event, and transmit an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

Another apparatus for wireless communication at a UE is described. The apparatus may include means for receiving a set of multiple downlink transmissions from a base station, means for identifying a CSI trigger event, and means for transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

A non-transitory computer-readable medium storing code for wireless communication at a UE is described. The code may include instructions executable by a processor to receive a set of multiple downlink transmissions from a base station, identify a CSI trigger event, and transmit an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

Some examples of the method, apparatuses, and non-transitory computer-readable medium described herein may further include operations, features, means, or instructions for identifying, based on the time, a first quantization level for a first downlink transmission and a second quantization level for a second downlink transmission that occurs after the first downlink transmission and indicating first CSI for the first downlink transmission using the first quantization level and second CSI for the second downlink transmission using the second quantization level in the accumulated CSI report, where the first CSI includes fewer information bits than the second CSI.

Some examples of the method, apparatuses, and non-transitory computer-readable medium described herein may further include operations, features, means, or instructions for receiving an indication of a set of quantization levels from the base station and identifying the quantization level for the CSI for each downlink transmission based on the set of quantization levels.

Some examples of the method, apparatuses, and non-transitory computer-readable medium described herein may further include operations, features, means, or instructions for receiving a trigger signal identifying a configuration for the accumulated CSI report, where the trigger signal includes the indication of the set of quantization levels.

Some examples of the method, apparatuses, and non-transitory computer-readable medium described herein may further include operations, features, means, or instructions for identifying a resource used for each downlink transmission from the base station, where the resource for each downlink transmission includes an indication of the quantization level for that downlink transmission.

Some examples of the method, apparatuses, and non-transitory computer-readable medium described herein may further include operations, features, means, or instructions for transmitting a quantization level request to the base station indicating quantization levels to use for each downlink transmission in the accumulated CSI report and receiving, based on the quantization level request, a signal identifying a configuration for the accumulated CSI report, where the configuration includes an indication of the quantization levels.

In some examples of the method, apparatuses, and non-transitory computer-readable medium described herein, the quantization level request may be transmitted in at least one of an uplink medium access control (MAC) control element (CE) or an uplink radio resource control (RRC) message, and the signal may be received in at least one of a downlink RRC message, a downlink MAC CE or downlink control information (DCI).

Some examples of the method, apparatuses, and non-transitory computer-readable medium described herein may further include operations, features, means, or instructions for identifying a first CSI for a first downlink transmission as a reference CSI and identifying a second CSI for a second downlink transmission as a differential CSI, where the quantization level for the second CSI indicates a difference between the second CSI and the first CSI.

In some examples of the method, apparatuses, and non-transitory computer-readable medium described herein, the first downlink transmission includes at least one of a latest downlink transmission, or a first downlink transmission, or an intermediate downlink transmission, in time relative to the CSI trigger event.

Some examples of the method, apparatuses, and non-transitory computer-readable medium described herein may further include operations, features, means, or instructions for receiving an indication of whether the accumulated CSI report includes a full CSI report or a differential CSI report, where the accumulated CSI report and the quantization level of the CSI for each downlink transmission may be based on the indication.

Some examples of the method, apparatuses, and non-transitory computer-readable medium described herein may further include operations, features, means, or instructions for identifying, based on a configuration for the accumulated CSI report, a bit-count limit for the accumulated CSI report, determining that the CSI for each downlink transmission in the accumulated CSI report includes a set of bits that exceed the bit-count limit, and discarding at least a portion of the CSI from the accumulated CSI report based on the set of bits exceeding the bit-count limit, where the discarded portion of the CSI may be associated with an oldest in time downlink transmission relative to the CSI trigger event.

In some examples of the method, apparatuses, and non-transitory computer-readable medium described herein, the quantization level of the CSI corresponds to a respective number of bits used to indicate each of one or more parameters included in the CSI for that downlink transmission.

A method for wireless communication at a base station is described. The method may include performing a set of multiple downlink transmissions to a UE and receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

An apparatus for wireless communication at a base station is described. The apparatus may include a processor, memory coupled with the processor, and instructions stored in the memory. The instructions may be executable by the processor to cause the apparatus to perform a set of multiple downlink transmissions to a UE and receive, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

Another apparatus for wireless communication at a base station is described. The apparatus may include means for performing a set of multiple downlink transmissions to a UE and means for receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

A non-transitory computer-readable medium storing code for wireless communication at a base station is described. The code may include instructions executable by a processor to perform a set of multiple downlink transmissions to a UE and receive, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

Some examples of the method, apparatuses, and non-transitory computer-readable medium described herein may further include operations, features, means, or instructions for identifying, based on the time, a first quantization level for a first downlink transmission and a second quantization level for a second downlink transmission that occurs after the first downlink transmission and determining first CSI for the first downlink transmission using the first quantization level and second CSI for the second downlink transmission using the second quantization level from the accumulated CSI report, where the first CSI includes fewer information bits than the second CSI.

Some examples of the method, apparatuses, and non-transitory computer-readable medium described herein may further include operations, features, means, or instructions for transmitting an indication of a set of quantization levels to the UE and determining the quantization level for the CSI for each downlink transmission based on the set of quantization levels.

Some examples of the method, apparatuses, and non-transitory computer-readable medium described herein may further include operations, features, means, or instructions for transmitting a trigger signal identifying a configuration for the accumulated CSI report, where the trigger signal includes the indication of the set of quantization levels.

Some examples of the method, apparatuses, and non-transitory computer-readable medium described herein may further include operations, features, means, or instructions for identifying a resource used for each downlink transmission to the UE, where the resource includes an indication of the quantization level for the downlink transmission.

Some examples of the method, apparatuses, and non-transitory computer-readable medium described herein may further include operations, features, means, or instructions for receiving a quantization level request from the UE indicating quantization levels to use for each downlink transmission in the accumulated CSI report and transmitting, based on the quantization level request, a signal identifying a configuration for the accumulated CSI report, where the configuration includes an indication of the quantization levels.

In some examples of the method, apparatuses, and non-transitory computer-readable medium described herein, the quantization level request may be received in at least one of an uplink MAC CE or an uplink RRC message, and the signal may be transmitted in at least one of a downlink RRC message, a downlink MAC CE or DCI.

Some examples of the method, apparatuses, and non-transitory computer-readable medium described herein may further include operations, features, means, or instructions for determining that a first CSI for a first downlink transmission may be a reference CSI and determining that a second CSI for a second downlink transmission may be a differential CSI, where the quantization level for the second CSI indicates a difference between the second CSI and the first CSI.

In some examples of the method, apparatuses, and non-transitory computer-readable medium described herein, the first downlink transmission includes at least one of a latest downlink transmission, or a first downlink transmission, or an intermediate downlink transmission, in time relative to the CSI trigger event.

Some examples of the method, apparatuses, and non-transitory computer-readable medium described herein may further include operations, features, means, or instructions for transmitting an indication of whether the accumulated CSI report includes a full CSI report or a differential CSI report, where the accumulated CSI report and the quantization level of the CSI for each downlink transmission may be based on the indication.

### BRIEF DESCRIPTION OF THE DRAWINGS

FIG. 1 illustrates an example of a wireless communications system that supports time-domain compression considerations for accumulated channel state information (CSI) reports in accordance with aspects of the present disclosure.

FIG. 2 illustrates an example of a wireless communications system that supports time-domain compression considerations for accumulated CSI reports in accordance with aspects of the present disclosure.

FIG. 3 illustrates an example of a CSI reporting configuration that supports time-domain compression considerations for accumulated CSI reports in accordance with aspects of the present disclosure.

FIGS. 4 and 5 show block diagrams of devices that support time-domain compression considerations for accumulated CSI reports in accordance with aspects of the present disclosure.

FIG. 6 shows a block diagram of a communications manager that supports time-domain compression considerations for accumulated CSI reports in accordance with aspects of the present disclosure.

FIG. 7 shows a diagram of a system including a device that supports time-domain compression considerations for accumulated CSI reports in accordance with aspects of the present disclosure.

FIGS. 8 and 9 show block diagrams of devices that support time-domain compression considerations for accumulated CSI reports in accordance with aspects of the present disclosure.

FIG. 10 shows a block diagram of a communications manager that supports time-domain compression considerations for accumulated CSI reports in accordance with aspects of the present disclosure.

FIG. 11 shows a diagram of a system including a device that supports time-domain compression considerations for accumulated CSI reports in accordance with aspects of the present disclosure.

FIGS. 12 through 16 show flowcharts illustrating methods that support time-domain compression considerations for accumulated CSI reports in accordance with aspects of the present disclosure.

### DETAILED DESCRIPTION

Wireless communications systems may use channel state information (CSI) measurement and reporting to track channel performance over time. For example, a base station may transmit CSI-reference signals (CSI-RSs), or other downlink transmissions, to user equipment (UE). The UE may determine CSI for the channel and report this to the base station in a CSI report. This may include the UE performing individual CSI-RS measurement and reporting (e.g., the UE measuring the reporting the CSI based on a single CSI-RS transmission). This may include the UE performing multiple CSI-RS measurements and then reporting full CSI reports for each CSI-RS measurement in an accumulated CSI-RS report. Accumulated CSI reporting may provide some advantages for certain communication types (e.g., ultra-reliable/low-latency communications (URLLC)), but uses a large amount of resources to communicate the full CSI reports. Accordingly, current techniques for CSI reporting are inefficient in various cases.

Generally, the described techniques provide for using quantization levels for some or all of the CSI reports within an accumulated CSI report to reduce the number of bits used to communicate the accumulated CSI report. For example, the UE may receive a plurality of downlink transmissions from a base station. This may include CSI-RS transmissions, physical downlink shared channel (PDSCH) transmissions, and the like, from the base station. The UE may identify or otherwise determine a CSI trigger event (e.g., an event initiating transmission of the accumulated CSI report). The UE may transmit or otherwise provide the accumulated CSI report to the base station in response to the CSI trigger event. The accumulated CSI report may use quantization levels of the CSI for each downlink transmission (e.g., for each CSI report of a downlink transmission in the accumulated CSI report). In some examples, the quantization levels may be based on the timing of the downlink transmission and the CSI trigger event. For example, the level of quantization level for the oldest CSI may be higher (e.g., use fewer bits) than more recent CSI. In some examples, the quantization level used for each CSI may include using fewer bits for the older CSI, using differential CSI values for some CSI relative to a reference CSI, and the like. Accordingly, the UE may transmit or otherwise provide the accumulated CSI report to the base station using fewer bits based on quantization levels.

Aspects of the disclosure are initially described in the context of wireless communications systems. Aspects of the disclosure are further illustrated by and described with reference to apparatus diagrams, system diagrams, and flowcharts that relate to time-domain compression considerations for accumulated CSI reports.

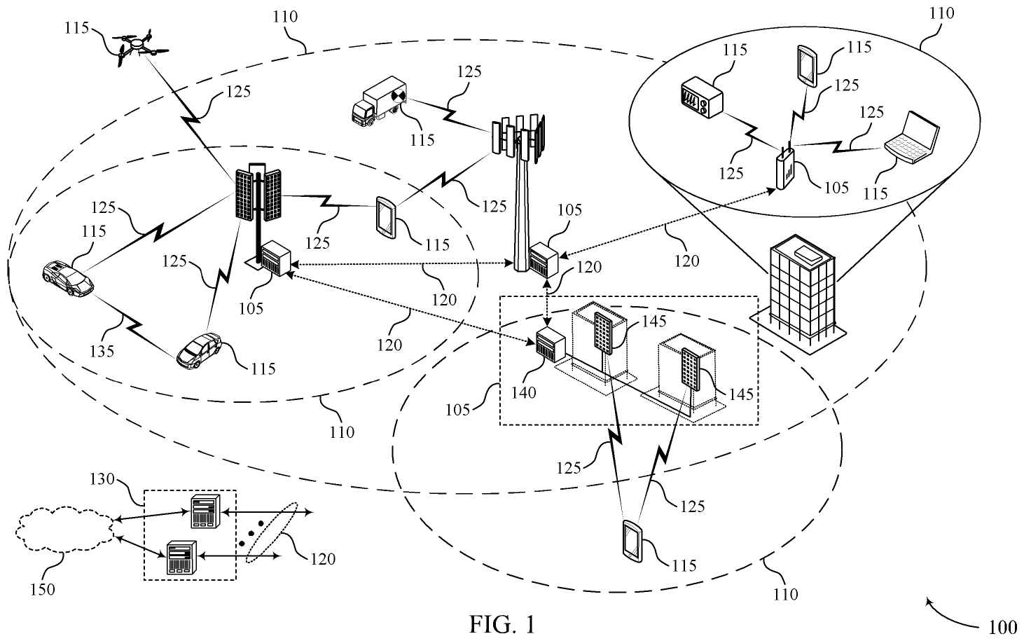

FIG. 1 illustrates an example of a wireless communications system 100 that supports time-domain compression considerations for accumulated CSI reports in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may receive a plurality of downlink transmissions from a base station 105. The UE 115 may identify a CSI trigger event. The UE 115 may transmit an accumulated CSI report comprising CSI for each downlink transmission of the plurality of downlink transmissions in accordance with the CSI trigger event, wherein a quantization level of the CSI for each downlink transmission in the accumulated CSI report is based at least in part on a time between the downlink transmission and the CSI trigger event.

A base station 105 may perform a plurality of downlink transmissions to a UE 115. The base station 105 may receive, from the UE 115, an accumulated CSI report comprising CSI for each downlink transmission of the plurality of downlink transmissions in accordance with a CSI trigger event, wherein a quantization level of the CSI for each downlink transmission in the accumulated CSI report is based at least in part on a time between the downlink transmission and the CSI trigger event

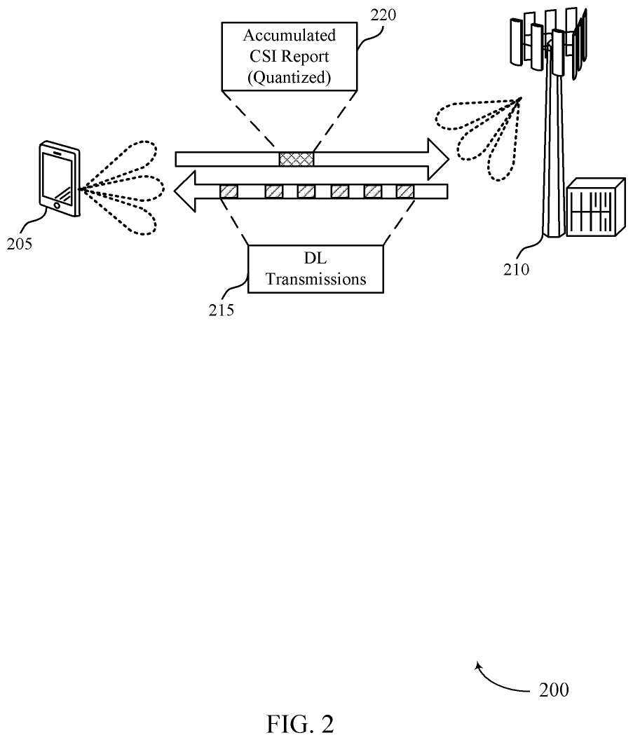

FIG. 2 illustrates an example of a wireless communications system 200 that supports time-domain compression considerations for accumulated CSI reports in accordance with aspects of the present disclosure. Wireless communications system 200 may implement aspects of wireless communications system 100. Wireless communications system 200 may include UE 205 and/or base station 210, which may be examples of the corresponding devices described herein.

Wireless communications system 200 may support CSI measurement and reporting. Generally, this may include (in the downlink example) base station 210 transmitting various downlink transmissions 215 to UE 205. Examples of the downlink transmissions 215 include, but are not limited to, CSI-RS transmissions, PDSCH transmissions, demodulation reference signal (DMRS) transmissions, tracking reference signal (TRS) transmissions, beam refinement reference signal (BRRS) transmissions, synchronization signal transmissions, and the like.

Resources for the downlink transmissions 215 may be identified or otherwise indicated to UE 205 to monitor the resources and identify or otherwise determine a CSI report for each downlink transmission 215. This may include, but is not limited to, UE 205 monitoring, measuring, identifying, or otherwise determining a reference signal received power (RSRP), a reference signal strength indicator (RSSI), an error rate, a throughput rate, a channel quality indicator (CQI), and the like. Each downlink transmission 215, and associated CSI report for the downlink transmission 215, may be associated with a channel between UE 205 and base station 210. That is, each downlink transmission 215 may be associated with a particular layer, spatial configuration, antenna configuration, transmit beam of base station 210, receive beam of UE 205, transmit/receive beam pair of base station 210 and UE 205, and the like. Accordingly, UE 205 may generally prepare a CSI report for each downlink transmission 215 from base station 210.

For example, UE 205 may transmit or otherwise provide the CSI report to base station 210 in response to a CSI trigger event. The CSI trigger event may include a periodic or semi-persistent trigger state configured by base station 210 where the CSI report is transmitted periodically or semi-persistently. The CSI trigger event may include an aperiodic trigger state where base station 210 transmits a trigger signal (e.g., via medium access control (MAC) control element (CE) and/or downlink control information (DCI)) to UE 205 triggering the CSI report. A downlink triggered aperiodic CSI report may reduce latency, increase reliability, and the like. If the DCI triggered CSI-RS is used (e.g., the downlink transmission 215 is a CSI-RS whose transmission is triggered by a downlink DCI), the CSI trigger field may use Z bits to indicate the CSI trigger state, which may include the CSI report settings/configuration/format as well as the CSI resource setting. In some examples, the CSI report may be provided along with an acknowledgement/negative-acknowledgement (ACK/NACK) in the same physical uplink control channel (PUCCH) transmission or in different PUCCH transmissions.

There may be different approaches for UE 205 to use to provide the CSI report to base station 210. One approach may include UE 205 transmitting or otherwise providing multiple CSI reports. For example, UE 205 may prepare and transmit a CSI report for each downlink transmission 215 from base station 210. In some examples of the multiple CSI reporting approach, UE 205 may include a full CSI report for one downlink transmission 215 (which may be referred to as a reference CSI report), and then include differential CSI reporting for X number of subsequent CSI reports, where X is a positive integer. The differential CSI report may include, rather than the full CSI report for the X subsequent CSI reports, an indication of the difference between the reference CSI report and the current CSI report. The positive integer X in this example (e.g., how many subsequent CSI reports indicate differential information) may be based on various factors, such as the rate of change for the channel conditions, UE mobility, and the like. This may be due to the age of the CSI report (e.g., the reference CSI report in this example) along with the change rate of the channel resulting in older CSI reports being less representative of the current channel performance conditions than newer (e.g., more recent in the time domain) CSI report(s).

Another approach to CSI reporting includes UE 205 transmitting a single CSI report (e.g., an accumulated CSI report) that carries or otherwise conveys multiple CSI reports to base station 210. For example, UE 205 may prepare a CSI report for each downlink transmission 215, but may save, store, or otherwise collect multiple CSI reports (e.g., CSI for each downlink transmission 215) and then including each CSI report in the accumulated CSI report. This approach generally relies on time domain compression in the single CSI report where base station 210 uses time correlation to predict the PDSCH channel (e.g., base station 210 may determine the channel performance based on the single CSI report). However, this approach consumes considerable resources by conveying the full CSI report for each downlink transmission 215 in the single CSI report.

In one example of the single or accumulated CSI reporting approach, this may include base station 210 retrieving up to M CSI reports from UE 205 upon the occurrence of the trigger event. For example, UE 205 may send the latest (unexpired) M (non-shared) CSI repots once an event occurs. This event may be based on a configured mode. A first mode (e.g., Mode 1) may include or be based on an ACK with certain low quality (bad log-likelihood ratios (LLRs), which uses a two stage uplink control information (UCI) (e.g., PUCCH). A second mode (e.g., Mode 2) may include or be based on a NACK (or observing X NACKs within L transmissions). A third mode (e.g., Mode 3) may include an indicator (e.g., DCI) from base station 210. A fourth mode (e.g., Mode 4) may include some combination of Modes 1-3. In these examples, variables X, M, L may all be RRC/MAC-CE configured parameters (e.g., N≥M may be initially part of UE capability signaling from UE 205). Base station 210 may indicate to UE 205 to report certain CSI from the last M transmissions (e.g., a CSI max buffer of UE 205 may be M, such that a bitmap of size M could be used. In the case of NACK triggering the CSI reporting, UE 205 may maintain a buffer of CSI reports corresponding to ACKs, then share M values of them once a NACK is observed.

An expiration time for CSI reports may be based on a timer configured by base station 210 for UE 205 using RRC or MAC-CE signaling. The expiration time (e.g., CSI report aging) may generally be based on the coherence time of the channel (e.g., part a function of doppler). As one example, if M=1, then once a NACK is observed UE 205 may send the CSI report of that one (e.g., for the downlink transmission 215 associated with the NACK). As another example, if M=2, then UE 205 may send the CSI report of the NACK'd grant (e.g., the downlink transmission 215 associated with the NACK) as well as the second grant (e.g., for the next downlink transmission 215). As another example, if M=3, then UE 205 may sends the CSI report of the NACK'd grant (e.g., the downlink transmission 215 associated with the NACK) as well as the previous two ACK'd ones (e.g., for the previous two downlink transmissions 215 that were successfully received and decoded by UE 205).

To improve the transmission performance, especially for high reliability services such as ultra-reliable low-latency communications (URLLC), base station 210 may request UE 205 to send a CSI report that contains a list of previous (unexpired) (and unshared) CSI reports (e.g., the single or accumulated CSI report). This may include base station 210 requesting the CSI report by indication (e.g., using DCI or dedicated configured resources to collect a set of CSI measurements across multiple instances) or by event-triggering (e.g., such as observing multiple NACKs or multiple barely passing transport blocks (TBs). which may correspond to weak ACKs). Base station 210 may generally collect this information to rectify its outer-loop behavior. In addition, base station 210 may compute, identify, or otherwise determine various statistics to improve the CSI-RS configurations as well as the PDSCH transmission parameters (improving new (re) transmission reliability). By using this information, along with some observations at the base station 210 side, base station 210 may compute, measure, identify, or otherwise determine some statistics and measurements on the predicted interference observed by UE 205 (e.g., comparing good and bad CSI cases, etc., which may be easier to understand with soft CSI reporting across time).

Accordingly, aspects of the techniques described herein provide various mechanisms for compression and/or quantization of the bits for buffered CSI reports (e.g., an accumulated CSI report 220) transmitted by UE 205. For example, UE 205 may receive and measure a plurality of downlink transmissions 215 from base station 210. The downlink transmissions 215 may include CSI-RS transmissions, PDSCH transmissions, and the like, from base station 210. UE 205 may measure, identify, or otherwise determine a CSI report for each downlink transmission 215. UE 205 may buffer or otherwise store/save each unreported CSI report.

Base station 210 and/or UE 205 may initiate, detect, identify, or otherwise determine that a CSI trigger event has occurred. The CSI trigger may be dynamic (e.g., aperiodic) based on a triggering DCI and/or based on an event occurring (e.g., NACK(s) being detected). The CSI trigger may be static (e.g., periodic or semi-persistent), such as based on configuration signaling. In response to the CSI trigger event occurring, UE 205 may transmit or otherwise provide the accumulated CSI report 220 to base station 210. The accumulated CSI report 220 may include CSI for each downlink transmission 215 (e.g., a separate CSI report for each downlink transmission 215). That is, the accumulated CSI report 220 may include unexpired and unreported CSI reports for each downlink transmission 215.

In some aspects, the accumulated CSI report 220 may include or otherwise use quantization level(s) for the CSI for each downlink transmission 215. Broadly, the quantization level for each CSI in the accumulated CSI report 220 may be based on the time between the downlink transmission 215 (e.g., the age of each CSI report) and the CSI trigger event (e.g., when the accumulated CSI report 220 is triggered for transmission). That is, aspects of the techniques describe herein beneficially provide, in the situation where backlogging/buffering of M CSI reports from downlink triggered CSI-RS or PDSCH or accumulation of CSI-RS resources, for compression of the CSI report. Generally, the quantization level of applied to each CSI report in the accumulated CSI report 220 may be configured such that fewer bits are included for CSI reports that are older in the time domain than other CSI reports in the accumulated CSI report 220.

For example, some aspects may include UE 205 and/or base station 210 selecting, identifying, or otherwise determining a first quantization level for a first downlink transmission (e.g., a first quantization level applied to the CSI report for the first downlink transmission) and a second quantization level for a second downlink transmission (e.g., a second quantization level applied to the CSI report for the second downlink transmission. The second downlink transmission in this example may occur after the first downlink transmission (e.g., may be older in the time domain). The accumulated CSI report 220 may carry, include, or otherwise convey a first CSI for the first downlink transmission using the first quantization level and a second CSI for the second downlink transmission using the second quantization level. The second quantization level for the second CSI report may be selected or otherwise configured so as to include fewer bits (e.g., less bits, which may indicate less-fine granularity for the CSI report) than the first quantization level used for the first CSI report. That is, the older CSI report(s) (in the time domain) in the accumulated CSI report 220 may be indicated using fewer bits than the newer or more recent CSI reports (in the time domain).

More particularly, the accumulated CSI report 220 may use quantization levels that are based on a function of time aging for the CSI reports in the accumulated CSI report 220. A quantization level is the numeric quantity of bits used to represent an individual CSI report. A more recent CSI report may have a higher quantization level, meaning that more bits are used to represent the CSI report. An older CSI report may have a lower quantization level, meaning that fewer bits are used to represent the CSI report. As such, the quantization level reflects the precision or granularity at which an individual CSI report is signaled, and as such the accumulated CSI report 220 may include multiple CSI reports of different levels of precision or granularity.

As one non-limiting example, this may include a situation where time two (t2) associated with CSI_2 (e.g., the second CSI report) is greater than time one (t1) associated with CSI_1 (e.g., the first CSI report), that is CSI_1 is older in the time domain than CSI_1. In this example, the quantization level for CSI_2 may be higher (e.g., use fewer bits to convey the quantities within the second CSI report in the accumulated CSI report 220) than the quantization level for CSI_1 (e.g., use more bits to convey the quantities within the first CSI report in the accumulated CSI report 220).

In some examples, base station 210 may transmit or otherwise provide to UE 205 signaling that configures the quantization levels to be used for the accumulated CSI report 220. That is, the quantization levels to be used for the CSI reports included in the accumulated CSI report 220 may be signaled as part of the CSI-RS report configuration. For example, base station 210 may transmit or otherwise provide an indication of a set of quantization levels to UE 205. UE 205 may use the indicated set of quantization levels for the CSI for each downlink transmission in the accumulated CSI report 220. For example, UE 205 may apply a first quantization level to a first CSI report associated with a first downlink transmission, a second quantization level to a second CSI report associated with a second downlink transmission, and so on, for some or each CSI report in the accumulated CSI report 220. In some examples, the indication of the set of quantization levels may be provided in the trigger signal (e.g., the DCI serving at the CSI trigger event) or may be provided in different signaling (e.g., RRC signaling, MAC CE signaling, a separate DCI, and the like).

In some examples, each CSI-RS resource may have a certain quantization level associated with it. For example, UE 205 and/or base station 210 may select, identify, or otherwise determine the resource used for each downlink transmission from base station 210. The resource may be identified, in some examples, based on the signaling configuring the CSI-RS resource for UE 205 to monitor. A downlink transmission, and the associated CSI report included in the accumulated CSI report 220, detected by UE 205 on a given resource may signal which quantization level to be used for the respective CSI report.

In some examples, UE 205 may request, recommend, or otherwise suggest the quantization level (or number of bits for each quantity used to indicate a CSI report within the accumulated CSI report 220) for each aged CSI (e.g., for each unexpired and unreported CSI report in the accumulated CSI report 220). UE 205 may send this information in an uplink MAC-CE, in a UE user-assistant information (e.g., carried in RRC), and the like. Based on UE 205 recommendation, base station 210 may update or change the quantization levels (or number of bits used to indicate each quantity/parameter within a CSI report) using RRC signaling, MAC-CE, DCI, and the like. Again, the quantities/parameters indicated in the CSI report for some or each downlink transmission may include, but are not limited to, a precoding matrix indicator (PMI), a rank indicator (RI), CQI, RSRP, strongest layer indicator (SLI), and the like. Accordingly, UE 205 may transmit or otherwise provide a quantization level request to base station 210 indicating the quantization levels to use for each downlink transmission in the accumulated CSI report 220 (e.g., for each CSI report in the accumulated CSI report 220). Base station 210 may transmit or otherwise provide signaling to UE 205 identifying the configuration for the accumulated CSI report 220 (e.g., CSI reporting configuration signaling, which may be provided using RRC signaling, MAC CE, DCI, and the like). The configuration may indicate the quantization levels to use for the accumulated CSI report 220.

In some examples, the quantization levels used for the CSI reports in the accumulated CSI report 220 may use differential reporting techniques relative to a reference CSI. For example, a first CSI (e.g., a first CSI report within the accumulated CSI report 220) for a first downlink transmission may be selected, identified, or otherwise determined as a reference CSI. The reference CSI (e.g., the first CSI report) may be the latest or most recent CSI in the time domain (e.g., correspond to the most recent downlink transmission), to the least in time (e.g., the newest CSI report in the accumulated CSI report 220), to the oldest in time (e.g., correspond to the first downlink transmission received in the time domain), or any other CSI (e.g., corresponding to an intermediate downlink transmission) included in the accumulated CSI report 220. In some aspects of this example, the reference CSI may refer to an average across all CSI reports included in the accumulated CSI report. In this example, UE 205 may select, identify, or otherwise determine a second CSI for a second downlink transmission as a differential CSI report. For example, UE 205 may select, identify, or otherwise indicate a differential quantity/value for each CSI report in the accumulated CSI report 220 relative to the reference CSI report.

In some examples, base station 210 may signal or otherwise indicate to UE 205 which CSI reports in the accumulated CSI report 220 are differential CSI reports relative to the reference CSI report and which CSI reports in the accumulated CSI report 220 are full CSI reports. For example, base station 210 may transmit or otherwise provide an indication of whether the accumulated CSI report 220 includes a full CSI report or a differential CSI report. In response, UE 205 may use quantization levels for each CSI report in the accumulated CSI report 220 based on the indication received from base station 210.

In some examples and for each CSI report included in the accumulated CSI report 220, the older the CSI-RS/PDSCH (e.g., downlink transmissions) in the time domain then the fewer or less bits may be assigned to the respective CSI report in the accumulated CSI report 220. UE 205 may discard unnecessary contents from the accumulated CSI report 220 (e.g., may discard CQI or PMI from older CSI reports or subband (SB) CQIs/PMIs). This may be based on configuration signaling received from base station 210. For example, UE 205 may identify, determine, or otherwise be configured with a bit-count limit for the accumulated CSI report 220 (e.g., based on signaling received from base station 210). UE 205 may identify or otherwise determine that the CSI for each downlink transmission in the accumulated CSI report 220 includes a set of bits exceeding the bit-count limit configured for UE 205. Accordingly, UE 205 may discard at least some of the CSI from the accumulated CSI report 220 in response. For example, UE 205 may discard some or all of the oldest CSI report(s) in the time domain from the accumulated CSI report 220 relative to the CSI trigger event.

Accordingly, wireless communications system 200 may be configured such that UE 205 may provide a single CSI report (e.g., the accumulated CSI report 220) to base station 210, which may use quantization levels for each CSI report in the accumulated CSI report 220 to reduce the size (e.g., fewer bits) and conserve resources. This may improve the CSI measurement and reporting process between UE 205 and base station 210, which may provide a more accurate picture of the channel performance. This may result in improved resource scheduling and communications between UE 205 and base station 210.

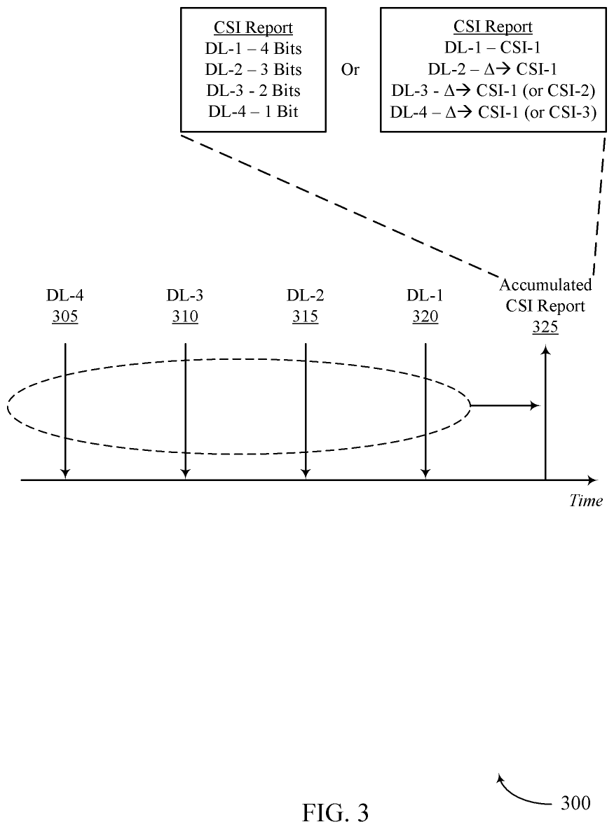

FIG. 3 illustrates an example of a CSI reporting configuration 300 that supports time-domain compression considerations for accumulated CSI reports in accordance with aspects of the present disclosure. CSI reporting configuration 300 may implement aspects of wireless communications systems 100 and/or 200. For example, aspects of CSI reporting configuration 300 may be implemented by or implemented at a UE and/or base station, which may be examples of the corresponding devices described herein.

As discussed above, aspects of the techniques described herein provide various mechanisms for reducing the size of an accumulated CSI report 325. For example, the base station may transmit or otherwise provide multiple downlink transmissions to a UE. In the non-limiting example illustrated in FIG. 3, this includes the base station performing a fourth downlink transmission (DL-4 305), a third downlink transmission (DL-3 310), a second downlink transmission (DL-2 315), and a first downlink transmission (DL-1 320) to the UE, although the plurality of downlink transmissions may include more or fewer than four downlink transmissions. Generally, DL-4 305 is performed first in the time domain, DL-3 310 is performed second in the time domain (e.g., after DL-4 305), DL-2 315 is performed third in the time domain (e.g., after DL-3 310), and DL-1 320 is performed fourth in the time domain (e.g., after DL-2 315). Accordingly, DL-4 305 is older in the time domain than DL-3 310, DL-3 310 is older in the time domain than DL-3 315, etc.

The UE may measure, identify, prepare, or otherwise determine a CSI report for each downlink transmission. Examples of the CSI report for each downlink transmission may include one, some, or all of a PMI, RI, CQI, RSRP, SLI, etc. The UE may prepare the accumulated CSI report 325 for transmission to the base station based on identifying, detecting, or otherwise determining a CSI trigger event (e.g., a DCI trigger and/or based on detecting a threshold condition, such as a NACK). The UE may transmit or otherwise provide the accumulated CSI report 325 to the base station in response to the CSI trigger event.

The accumulated CSI report 325 may use quantization levels for one, some, or all of the CSI reports included in the accumulated CSI report 325. Broadly, the quantization levels may be configured such that older CSI reports in the accumulated CSI report 325 use fewer resources to convey the CSI report.

As one non-limiting example, this may include using fewer bits for each CSI report based on the quantization level. For example and based on the age of each downlink transmission, fewer and fewer bits may be used to represent or otherwise convey the CSI report for the downlink transmission in the accumulated CSI report 220. This may include, but is not limited to, the accumulated CSI report 325 using four bits for the first CSI report for DL-1 320, using three bits for the second CSI report for DL-2 315, using two bits for the third CSI report for DL-3 310, and using only one bit for the fourth CSI report for DL-4 305. That is, as DL-4 305 is the oldest downlink transmission in the time domain, fewer bits may be used to represent its associated CSI report in the accumulated CSI report 325.

Another non-limiting example may include using differential values in the accumulated CSI report 325. In this non-limiting example, the CSI report for the most recent or newest downlink transmission may be designated as the reference CSI report and other CSI reports indicate differential quantities/values relative to the reference CSI report. For example, the CSI report for DL-1 320 (e.g., the newest or most recent downlink transmission in the time domain) may include a full CSI report, which may be designated as the reference CSI report. The CSI report for DL-2 315 may signal a differential value relative to the CSI report for DL-1 320. The CSI report for DL-3 310 may signal a differential value relative to the CSI report for DL-2 315 or relative to DL-1 320, depending on the configuration for the accumulated CSI report 325. The CSI report for DL-4 305 may signal a differential value relative to the CSI report for DL-3 310 or relative to DL-1 320, depending on the configuration for the accumulated CSI report 325. However, in other examples a different CSI report for a different downlink transmission may be designated as the reference CSI report, such as DL-4 305 (e.g., the oldest or first downlink transmission indicated in accumulated CSI report 325) or an intermediate downlink transmission (e.g., DL-3 310 or DL-2 315).

Accordingly, in these examples the accumulated CSI report 325 may indicate CSI reports for each downlink transmission in a more efficient manner using less resources than sending the full CSI reports for each downlink transmission. This may improve the CSI measurement and reporting process between the UE and base station, which may provide a more accurate picture of the channel performance. This may result in improved resource scheduling and communications between the UE and base station.

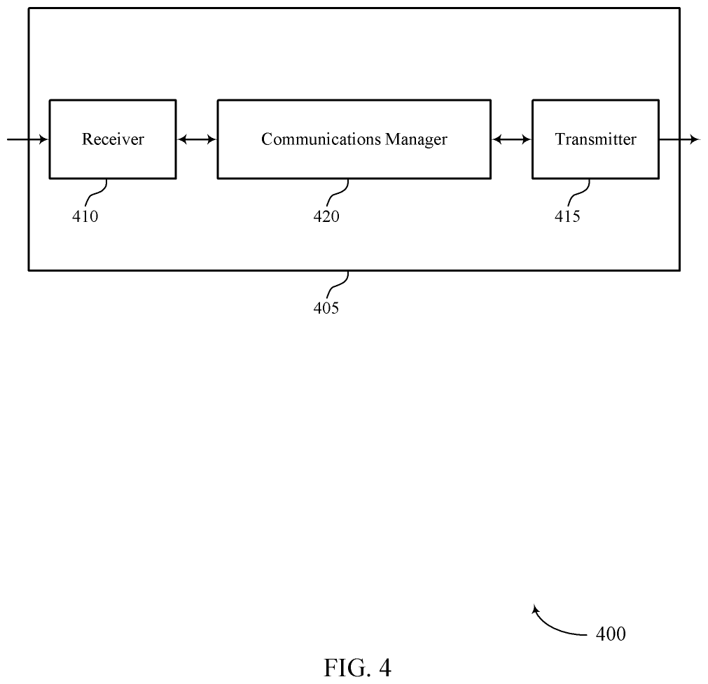

FIG. 4 shows a block diagram 400 of a device 405 that supports time-domain compression considerations for accumulated CSI reports in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to time-domain compression considerations for accumulated CSI reports). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to time-domain compression considerations for accumulated CSI reports). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of time-domain compression considerations for accumulated CSI reports as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving a set of multiple downlink transmissions from a base station. The communications manager 420 may be configured as or otherwise support a means for identifying a CSI trigger event. The communications manager 420 may be configured as or otherwise support a means for transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for improving CSI measurement and reporting using different quantization levels for one, some, or all of the CSI reports included in an accumulated CSI report.

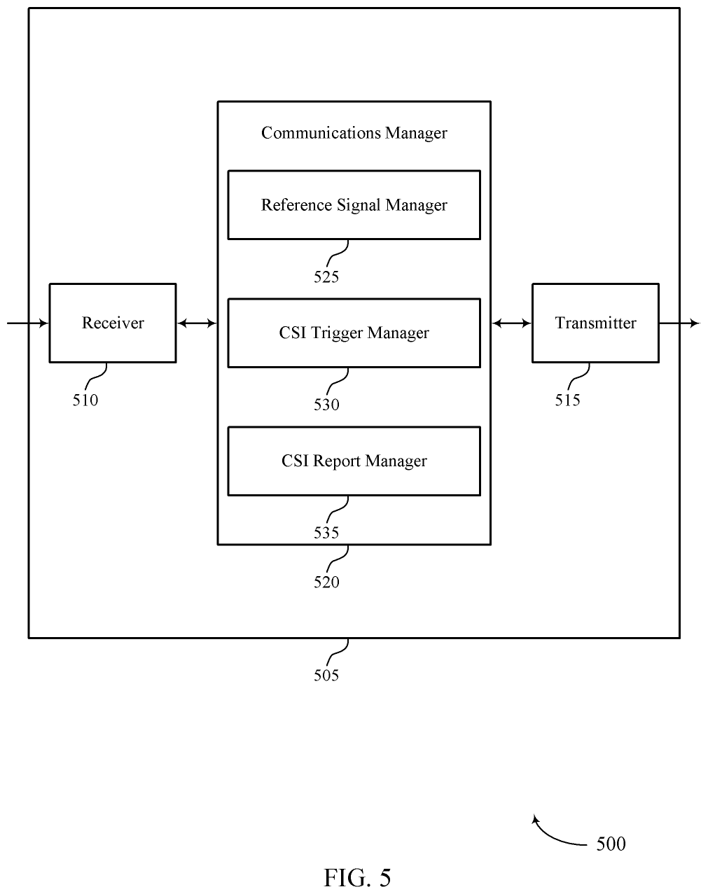

FIG. 5 shows a block diagram 500 of a device 505 that supports time-domain compression considerations for accumulated CSI reports in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to time-domain compression considerations for accumulated CSI reports). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to time-domain compression considerations for accumulated CSI reports). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of time-domain compression considerations for accumulated CSI reports as described herein. For example, the communications manager 520 may include a reference signal manager 525, a CSI trigger manager 530, a CSI report manager 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The reference signal manager 525 may be configured as or otherwise support a means for receiving a set of multiple downlink transmissions from a base station. The CSI trigger manager 530 may be configured as or otherwise support a means for identifying a CSI trigger event. The CSI report manager 535 may be configured as or otherwise support a means for transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

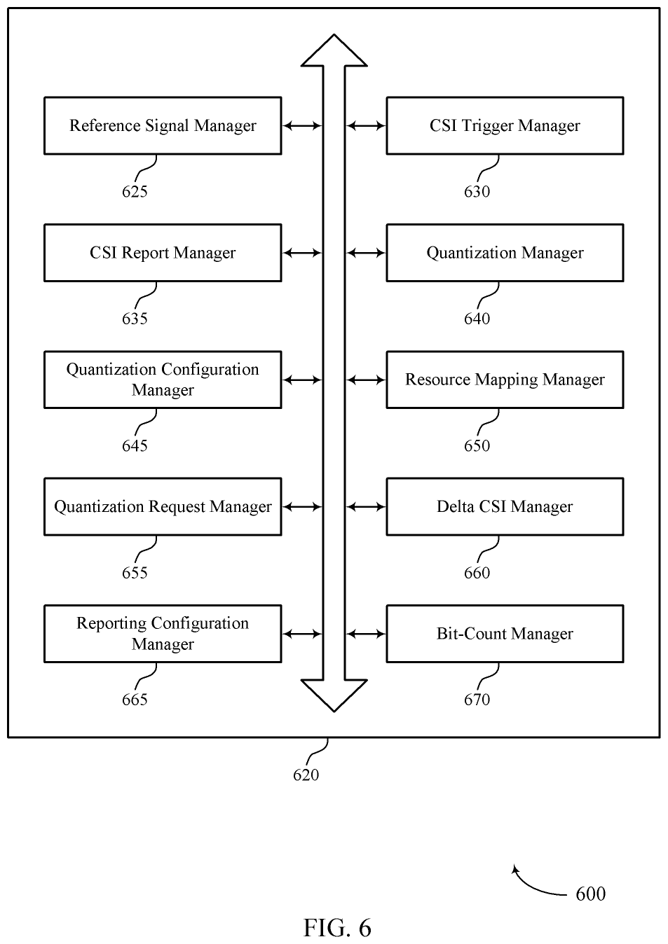

FIG. 6 shows a block diagram 600 of a communications manager 620 that supports time-domain compression considerations for accumulated CSI reports in accordance with aspects of the present disclosure. The communications manager 620 may be an example of aspects of a communications manager 420, a communications manager 520, or both, as described herein. The communications manager 620, or various components thereof, may be an example of means for performing various aspects of time-domain compression considerations for accumulated CSI reports as described herein. For example, the communications manager 620 may include a reference signal manager 625, a CSI trigger manager 630, a CSI report manager 635, a quantization manager 640, a quantization configuration manager 645, a resource mapping manager 650, a quantization request manager 655, a delta CSI manager 660, a reporting configuration manager 665, a bit-count manager 670, or any combination thereof. Each of these components may communicate, directly or indirectly, with one another (e.g., via one or more buses).

The communications manager 620 may support wireless communication at a UE in accordance with examples as disclosed herein. The reference signal manager 625 may be configured as or otherwise support a means for receiving a set of multiple downlink transmissions from a base station. The CSI trigger manager 630 may be configured as or otherwise support a means for identifying a CSI trigger event. The CSI report manager 635 may be configured as or otherwise support a means for transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

In some examples, the quantization manager 640 may be configured as or otherwise support a means for identifying, based on the time, a first quantization level for a first downlink transmission and a second quantization level for a second downlink transmission that occurs after the first downlink transmission. In some examples, the quantization manager 640 may be configured as or otherwise support a means for indicating first CSI for the first downlink transmission using the first quantization level and second CSI for the second downlink transmission using the second quantization level in the accumulated CSI report, where the first CSI includes fewer information bits than the second CSI.

In some examples, the quantization configuration manager 645 may be configured as or otherwise support a means for receiving an indication of a set of quantization levels from the base station. In some examples, the quantization configuration manager 645 may be configured as or otherwise support a means for identifying the quantization level for the CSI for each downlink transmission based on the set of quantization levels.

In some examples, the quantization configuration manager 645 may be configured as or otherwise support a means for receiving a trigger signal identifying a configuration for the accumulated CSI report, where the trigger signal includes the indication of the set of quantization levels.

In some examples, the resource mapping manager 650 may be configured as or otherwise support a means for identifying a resource used for each downlink transmission from the base station, where the resource for each downlink transmission includes an indication of the quantization level for that downlink transmission.

In some examples, the quantization request manager 655 may be configured as or otherwise support a means for transmitting a quantization level request to the base station indicating quantization levels to use for each downlink transmission in the accumulated CSI report. In some examples, the quantization request manager 655 may be configured as or otherwise support a means for receiving, based on the quantization level request, a signal identifying a configuration for the accumulated CSI report, where the configuration includes an indication of the quantization levels. In some examples, the quantization level request is transmitted in at least one of an uplink MAC CE or an uplink RRC message, and the signal is received in at least one of a downlink RRC message, a downlink MAC CE or DCI. In some examples, the quantization level of the CSI corresponds to a respective number of bits used to indicate each of one or more parameters included in the CSI for that downlink transmission.

In some examples, the delta CSI manager 660 may be configured as or otherwise support a means for identifying a first CSI for a first downlink transmission as a reference CSI. In some examples, the delta CSI manager 660 may be configured as or otherwise support a means for identifying a second CSI for a second downlink transmission as a differential CSI, where the quantization level for the second CSI indicates a difference between the second CSI and the first CSI. In some examples, the first downlink transmission includes at least one of a latest downlink transmission, or a first downlink transmission, or an intermediate downlink transmission, in time relative to the CSI trigger event.

In some examples, the reporting configuration manager 665 may be configured as or otherwise support a means for receiving an indication of whether the accumulated CSI report includes a full CSI report or a differential CSI report, where the accumulated CSI report and the quantization level of the CSI for each downlink transmission is based on the indication.

In some examples, the bit-count manager 670 may be configured as or otherwise support a means for identifying, based on a configuration for the accumulated CSI report, a bit-count limit for the accumulated CSI report. In some examples, the bit-count manager 670 may be configured as or otherwise support a means for determining that the CSI for each downlink transmission in the accumulated CSI report includes a set of bits that exceed the bit-count limit. In some examples, the bit-count manager 670 may be configured as or otherwise support a means for discarding at least a portion of the CSI from the accumulated CSI report based on the set of bits exceeding the bit-count limit, where the discarded portion of the CSI is associated with an oldest in time downlink transmission relative to the CSI trigger event.

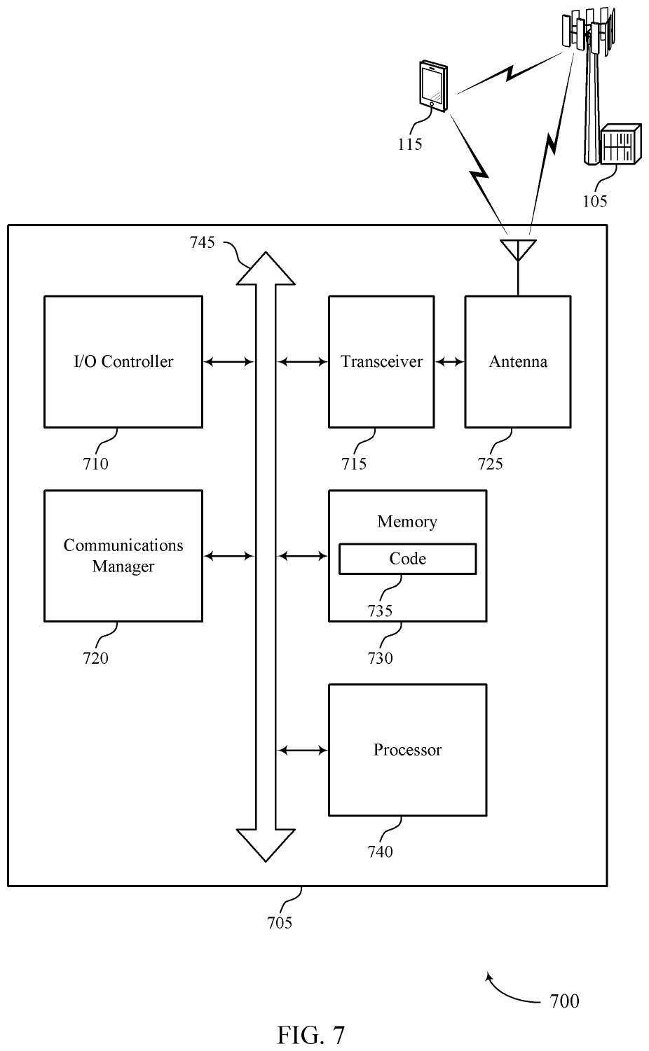

FIG. 7 shows a diagram of a system 700 including a device 705 that supports time-domain compression considerations for accumulated CSI reports in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting time-domain compression considerations for accumulated CSI reports). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving a set of multiple downlink transmissions from a base station. The communications manager 720 may be configured as or otherwise support a means for identifying a CSI trigger event. The communications manager 720 may be configured as or otherwise support a means for transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event.

By including or configuring the communications manager 720 in accordance with examples as described herein, the device 705 may support techniques for improving CSI measurement and reporting using different quantization levels for one, some, or all of the CSI reports included in an accumulated CSI report.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of time-domain compression considerations for accumulated CSI reports as described herein, or the processor 740 and the memory 730 may be otherwise configured to perform or support such operations.

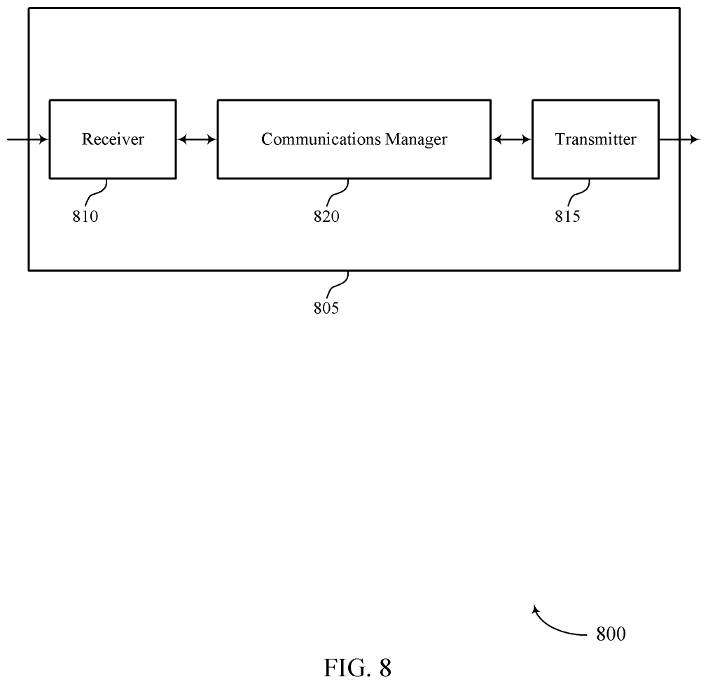

FIG. 8 shows a block diagram 800 of a device 805 that supports time-domain compression considerations for accumulated CSI reports in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to time-domain compression considerations for accumulated CSI reports). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to time-domain compression considerations for accumulated CSI reports). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of time-domain compression considerations for accumulated CSI reports as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a base station in accordance with examples as disclosed herein. For example, the communications manager 820 may be configured as or otherwise support a means for performing a set of multiple downlink transmissions to a UE. The communications manager 820 may be configured as or otherwise support a means for receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for improving CSI measurement and reporting using different quantization levels for one, some, or all of the CSI reports included in an accumulated CSI report.

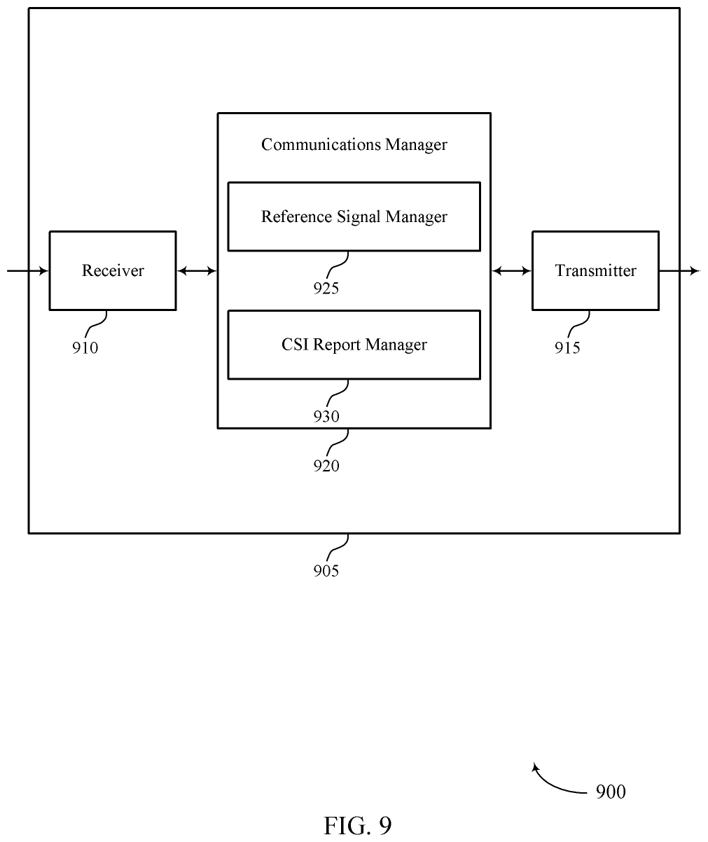

FIG. 9 shows a block diagram 900 of a device 905 that supports time-domain compression considerations for accumulated CSI reports in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to time-domain compression considerations for accumulated CSI reports). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to time-domain compression considerations for accumulated CSI reports). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of time-domain compression considerations for accumulated CSI reports as described herein. For example, the communications manager 920 may include a reference signal manager 925 a CSI report manager 930, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. The reference signal manager 925 may be configured as or otherwise support a means for performing a set of multiple downlink transmissions to a UE. The CSI report manager 930 may be configured as or otherwise support a means for receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

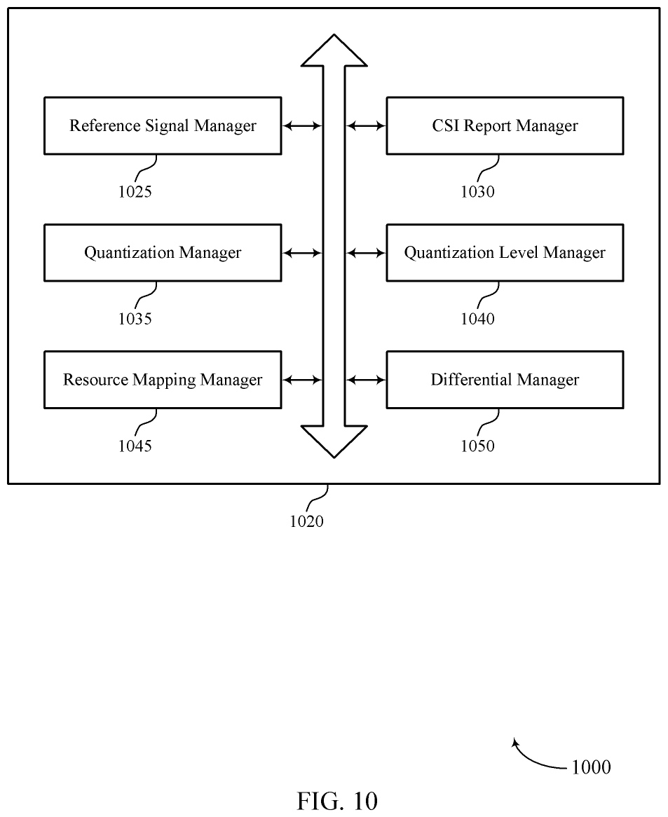

FIG. 10 shows a block diagram 1000 of a communications manager 1020 that supports time-domain compression considerations for accumulated CSI reports in accordance with aspects of the present disclosure. The communications manager 1020 may be an example of aspects of a communications manager 820, a communications manager 920, or both, as described herein. The communications manager 1020, or various components thereof, may be an example of means for performing various aspects of time-domain compression considerations for accumulated CSI reports as described herein. For example, the communications manager 1020 may include a reference signal manager 1025, a CSI report manager 1030, a quantization manager 1035, a quantization level manager 1040, a resource mapping manager 1045, a differential manager 1050, or any combination thereof. Each of these components may communicate, directly or indirectly, with one another (e.g., via one or more buses).

The communications manager 1020 may support wireless communication at a base station in accordance with examples as disclosed herein. The reference signal manager 1025 may be configured as or otherwise support a means for performing a set of multiple downlink transmissions to a UE. The CSI report manager 1030 may be configured as or otherwise support a means for receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

In some examples, the quantization manager 1035 may be configured as or otherwise support a means for identifying, based on the time, a first quantization level for a first downlink transmission and a second quantization level for a second downlink transmission that occurs after the first downlink transmission. In some examples, the quantization manager 1035 may be configured as or otherwise support a means for determining first CSI for the first downlink transmission using the first quantization level and second CSI for the second downlink transmission using the second quantization level from the accumulated CSI report, where the first CSI includes fewer information bits than the second CSI.

In some examples, the quantization level manager 1040 may be configured as or otherwise support a means for transmitting an indication of a set of quantization levels to the UE. In some examples, the quantization level manager 1040 may be configured as or otherwise support a means for determining the quantization level for the CSI for each downlink transmission based on the set of quantization levels.

In some examples, the quantization level manager 1040 may be configured as or otherwise support a means for transmitting a trigger signal identifying a configuration for the accumulated CSI report, where the trigger signal includes the indication of the set of quantization levels.

In some examples, the resource mapping manager 1045 may be configured as or otherwise support a means for identifying a resource used for each downlink transmission to the UE, where the resource for each downlink transmission includes an indication of the quantization level for that downlink transmission.

In some examples, the quantization level manager 1040 may be configured as or otherwise support a means for receiving a quantization level request from the UE indicating quantization levels to use for each downlink transmission in the accumulated CSI report. In some examples, the quantization level manager 1040 may be configured as or otherwise support a means for transmitting, based on the quantization level request, a signal identifying a configuration for the accumulated CSI report, where the configuration includes an indication of the quantization levels. In some examples, the quantization level request is received in at least one of an uplink MAC CE or an uplink RRC message, and the signal is transmitted in at least one of a downlink RRC message, a downlink MAC CE or DCI. In some examples, the quantization level of the CSI corresponds to a respective number of bits used to indicate each of one or more parameters included in the CSI for that downlink transmission.

In some examples, the differential manager 1050 may be configured as or otherwise support a means for determining that a first CSI for a first downlink transmission is a reference CSI. In some examples, the differential manager 1050 may be configured as or otherwise support a means for determining that a second CSI for a second downlink transmission is a differential CSI, where the quantization level for the second CSI indicates a difference between the second CSI and the first CSI. In some examples, the first downlink transmission includes at least one of a latest downlink transmission, or a first downlink transmission, or an intermediate downlink transmission, in time relative to the CSI trigger event.

In some examples, the differential manager 1050 may be configured as or otherwise support a means for transmitting an indication of whether the accumulated CSI report includes a full CSI report or a differential CSI report, where the accumulated CSI report and the quantization level of the CSI for each downlink transmission is based on the indication.

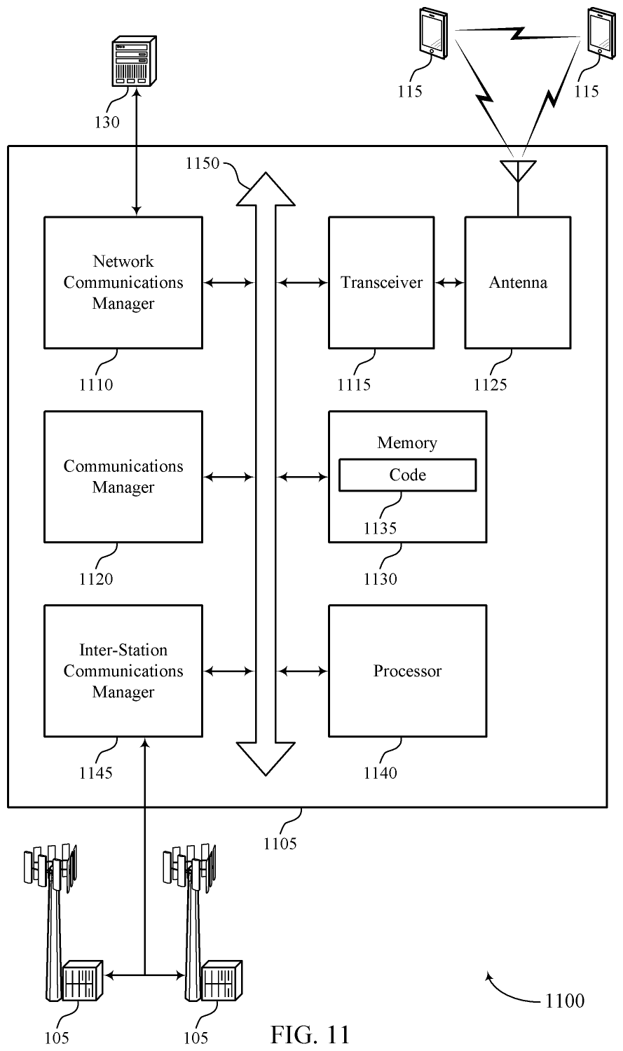

FIG. 11 shows a diagram of a system 1100 including a device 1105 that supports time-domain compression considerations for accumulated CSI reports in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting time-domain compression considerations for accumulated CSI reports). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a base station in accordance with examples as disclosed herein. For example, the communications manager 1120 may be configured as or otherwise support a means for performing a set of multiple downlink transmissions to a UE. The communications manager 1120 may be configured as or otherwise support a means for receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event.

By including or configuring the communications manager 1120 in accordance with examples as described herein, the device 1105 may support techniques for improving CSI measurement and reporting using different quantization levels for one, some, or all of the CSI reports included in an accumulated CSI report.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of time-domain compression considerations for accumulated CSI reports as described herein, or the processor 1140 and the memory 1130 may be otherwise configured to perform or support such operations.

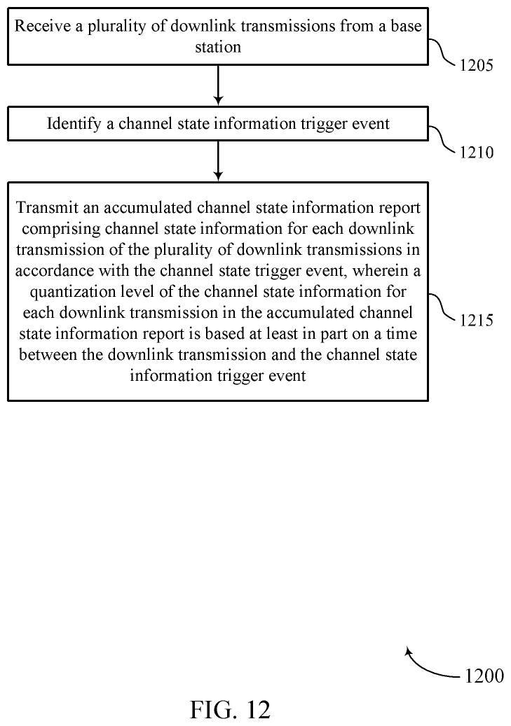

FIG. 12 shows a flowchart illustrating a method 1200 that supports time-domain compression considerations for accumulated CSI reports in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving a set of multiple downlink transmissions from a base station. The operations of 1205 may be performed in accordance with examples as disclosed herein. In some examples, aspects of the operations of 1205 may be performed by a reference signal manager 625 as described with reference to FIG. 6.

At 1210, the method may include identifying a CSI trigger event. The operations of 1210 may be performed in accordance with examples as disclosed herein. In some examples, aspects of the operations of 1210 may be performed by a CSI trigger manager 630 as described with reference to FIG. 6.

At 1215, the method may include transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event. The operations of 1215 may be performed in accordance with examples as disclosed herein. In some examples, aspects of the operations of 1215 may be performed by a CSI report manager 635 as described with reference to FIG. 6.

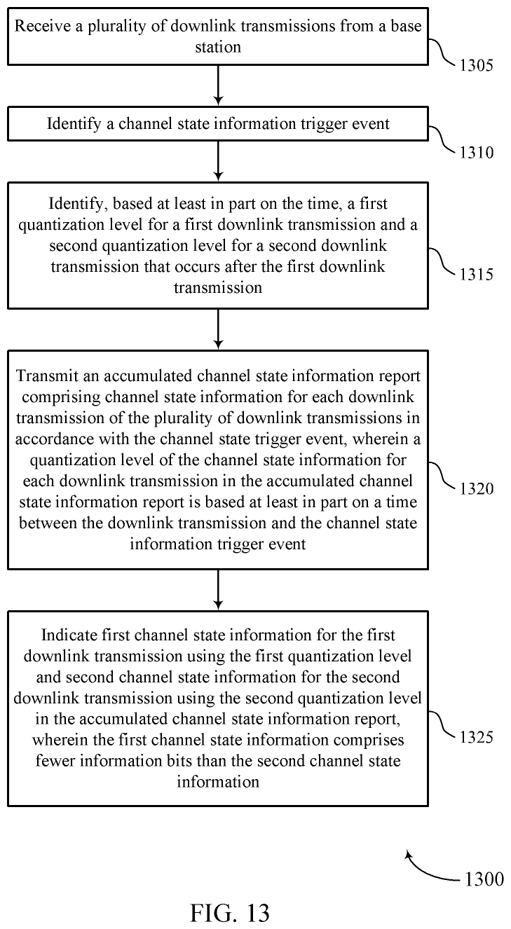

FIG. 13 shows a flowchart illustrating a method 1300 that supports time-domain compression considerations for accumulated CSI reports in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving a set of multiple downlink transmissions from a base station. The operations of 1305 may be performed in accordance with examples as disclosed herein. In some examples, aspects of the operations of 1305 may be performed by a reference signal manager 625 as described with reference to FIG. 6.

At 1310, the method may include identifying a CSI trigger event. The operations of 1310 may be performed in accordance with examples as disclosed herein. In some examples, aspects of the operations of 1310 may be performed by a CSI trigger manager 630 as described with reference to FIG. 6.

At 1315, the method may include identifying, based on the time, a first quantization level for a first downlink transmission and a second quantization level for a second downlink transmission that occurs after the first downlink transmission. The operations of 1315 may be performed in accordance with examples as disclosed herein. In some examples, aspects of the operations of 1315 may be performed by a quantization manager 640 as described with reference to FIG. 6.

At 1320, the method may include transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event. The operations of 1320 may be performed in accordance with examples as disclosed herein. In some examples, aspects of the operations of 1320 may be performed by a CSI report manager 635 as described with reference to FIG. 6.

At 1325, the method may include indicating first CSI for the first downlink transmission using the first quantization level and second CSI for the second downlink transmission using the second quantization level in the accumulated CSI report, where the first CSI includes fewer information bits than the second CSI. The operations of 1325 may be performed in accordance with examples as disclosed herein. In some examples, aspects of the operations of 1325 may be performed by a quantization manager 640 as described with reference to FIG. 6.

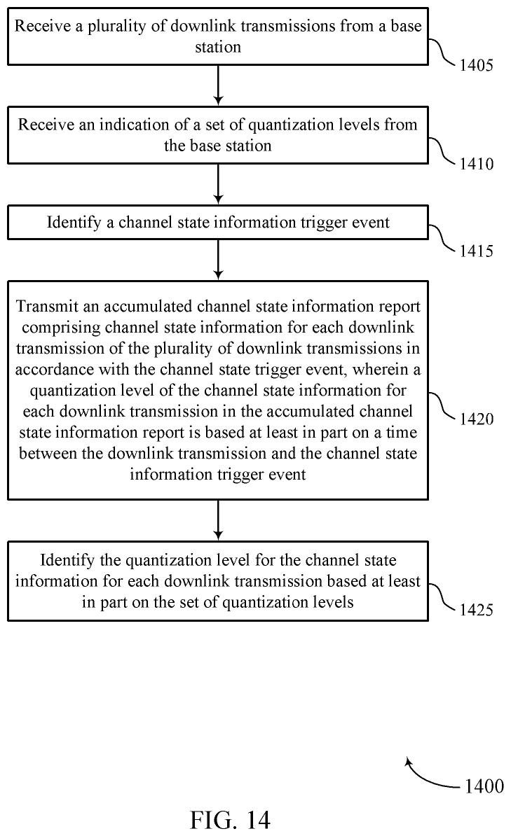

FIG. 14 shows a flowchart illustrating a method 1400 that supports time-domain compression considerations for accumulated CSI reports in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving a set of multiple downlink transmissions from a base station. The operations of 1405 may be performed in accordance with examples as disclosed herein. In some examples, aspects of the operations of 1405 may be performed by a reference signal manager 625 as described with reference to FIG. 6.

At 1410, the method may include receiving an indication of a set of quantization levels from the base station. The operations of 1410 may be performed in accordance with examples as disclosed herein. In some examples, aspects of the operations of 1410 may be performed by a quantization configuration manager 645 as described with reference to FIG. 6.

At 1415, the method may include identifying a CSI trigger event. The operations of 1415 may be performed in accordance with examples as disclosed herein. In some examples, aspects of the operations of 1415 may be performed by a CSI trigger manager 630 as described with reference to FIG. 6.

At 1420, the method may include transmitting an accumulated CSI report including CSI for each downlink transmission of the set of multiple downlink transmissions in accordance with the CSI trigger event, where a quantization level of the CSI for each downlink transmission in the accumulated CSI report is based on a time between the downlink transmission and the CSI trigger event. The operations of 1420 may be performed in accordance with examples as disclosed herein. In some examples, aspects of the operations of 1420 may be performed by a CSI report manager 635 as described with reference to FIG. 6.

At 1425, the method may include identifying the quantization level for the CSI for each downlink transmission based on the set of quantization levels. The operations of 1425 may be performed in accordance with examples as disclosed herein. In some examples, aspects of the operations of 1425 may be performed by a quantization configuration manager 645 as described with reference to FIG. 6.

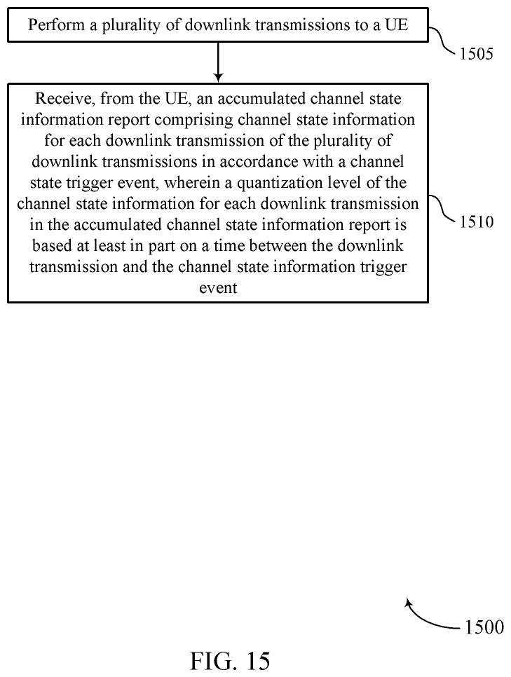

FIG. 15 shows a flowchart illustrating a method 1500 that supports time-domain compression considerations for accumulated CSI reports in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include performing a set of multiple downlink transmissions to a UE. The operations of 1505 may be performed in accordance with examples as disclosed herein. In some examples, aspects of the operations of 1505 may be performed by a reference signal manager 1025 as described with reference to FIG. 10.

At 1510, the method may include receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event. The operations of 1510 may be performed in accordance with examples as disclosed herein. In some examples, aspects of the operations of 1510 may be performed by a CSI report manager 1030 as described with reference to FIG. 10.

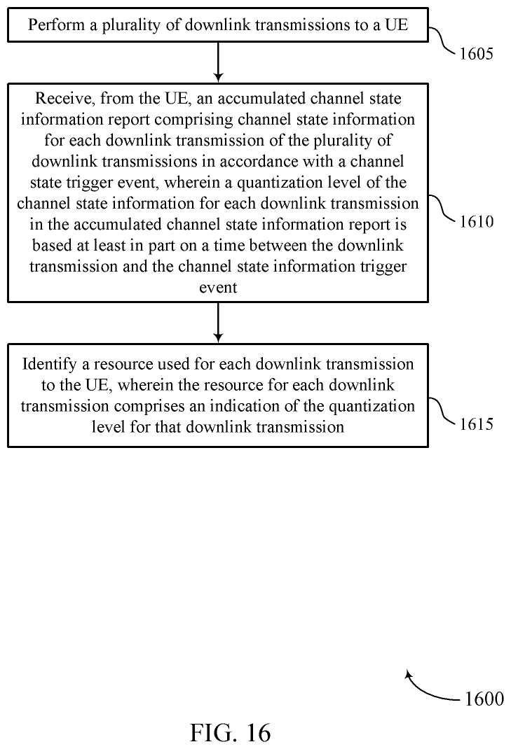

FIG. 16 shows a flowchart illustrating a method 1600 that supports time-domain compression considerations for accumulated CSI reports in accordance with aspects of the present disclosure. The operations of the method 1600 may be implemented by a base station or its components as described herein. For example, the operations of the method 1600 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1605, the method may include performing a set of multiple downlink transmissions to a UE. The operations of 1605 may be performed in accordance with examples as disclosed herein. In some examples, aspects of the operations of 1605 may be performed by a reference signal manager 1025 as described with reference to FIG. 10.

At 1610, the method may include receiving, from the UE, an accumulated CSI report including CSI for each downlink transmission of the set of multiple downlink transmissions in accordance with a CSI trigger event, where a quantization level of the CSI for each downlink transmission in the accumulated CSI report is based on a time between the downlink transmission and the CSI trigger event. The operations of 1610 may be performed in accordance with examples as disclosed herein. In some examples, aspects of the operations of 1610 may be performed by a CSI report manager 1030 as described with reference to FIG. 10.

At 1615, the method may include identifying a resource used for each downlink transmission to the UE, where the resource for each downlink transmission includes an indication of the quantization level for that downlink transmission. The operations of 1615 may be performed in accordance with examples as disclosed herein. In some examples, aspects of the operations of 1615 may be performed by a resource mapping manager 1045 as described with reference to FIG. 10.

The following provides an overview of aspects of the present disclosure:

Aspect 1: A method for wireless communication at a UE, comprising: receiving a plurality of downlink transmissions from a base station; identifying a CSI trigger event; and transmitting an accumulated CSI report comprising CSI for each downlink transmission of the plurality of downlink transmissions in accordance with the CSI trigger event, wherein a quantization level of the CSI for each downlink transmission in the accumulated CSI report is based at least in part on a time between the downlink transmission and the CSI trigger event.

Aspect 2: The method of aspect 1, further comprising: identifying, based at least in part on the time, a first quantization level for a first downlink transmission and a second quantization level for a second downlink transmission that occurs after the first downlink transmission; and indicating first CSI for the first downlink transmission using the first quantization level and second CSI for the second downlink transmission using the second quantization level in the accumulated CSI report, wherein the first CSI comprises fewer information bits than the second CSI.

Aspect 3: The method of any of aspects 1 through 2, further comprising: receiving an indication of a set of quantization levels from the base station; and identifying the quantization level for the CSI for each downlink transmission based at least in part on the set of quantization levels.

Aspect 4: The method of aspect 3, further comprising: receiving a trigger signal identifying a configuration for the accumulated CSI report, wherein the trigger signal comprises the indication of the set of quantization levels.

Aspect 5: The method of any of aspects 1 through 4, further comprising: identifying a resource used for each downlink transmission from the base station, wherein the resource for each downlink transmission comprises an indication of the quantization level for that downlink transmission.

Aspect 6: The method of any of aspects 1 through 5, further comprising: transmitting a quantization level request to the base station indicating quantization levels to use for each downlink transmission in the accumulated CSI report; and receiving, based at least in part on the quantization level request, a signal identifying a configuration for the accumulated CSI report, wherein the configuration comprises an indication of the quantization levels.

Aspect 7: The method of aspect 6, wherein the quantization level request is transmitted in at least one of an uplink MAC CE or an uplink RRC message, and the signal is received in at least one of a downlink RRC message, a downlink MAC CE or DCI.

Aspect 8: The method of any of aspects 1 through 7, further comprising: identifying a first CSI for a first downlink transmission as a reference CSI; and identifying a second CSI for a second downlink transmission as a differential CSI, wherein the quantization level for the second CSI indicates a difference between the second CSI and the first CSI.

Aspect 9: The method of aspect 8, wherein the first downlink transmission comprises at least one of a latest downlink transmission, or a first downlink transmission, or an intermediate downlink transmission, in time relative to the CSI trigger event.

Aspect 10: The method of any of aspects 1 through 9, further comprising: receiving an indication of whether the accumulated CSI report comprises a full CSI report or a differential CSI report, wherein the accumulated CSI report and the quantization level of the CSI for each downlink transmission is based at least in part on the indication.

Aspect 11: The method of any of aspects 1 through 10, further comprising: identifying, based at least in part on a configuration for the accumulated CSI report, a bit-count limit for the accumulated CSI report; determining that the CSI for each downlink transmission in the accumulated CSI report comprises a set of bits that exceed the bit-count limit; and discarding at least a portion of the CSI from the accumulated CSI report based at least in part on the set of bits exceeding the bit-count limit, wherein the discarded portion of the CSI is associated with an oldest in time downlink transmission relative to the CSI trigger event.

Aspect 12: The method of any of aspects 1 through 11, wherein the quantization level of the CSI corresponds to a respective number of bits used to indicate each of one or more parameters included in the CSI for that downlink transmission.

Aspect 13: A method for wireless communication at a base station, comprising: performing a plurality of downlink transmissions to a UE; and receiving, from the UE, an accumulated CSI report comprising CSI for each downlink transmission of the plurality of downlink transmissions in accordance with a CSI trigger event, wherein a quantization level of the CSI for each downlink transmission in the accumulated CSI report is based at least in part on a time between the downlink transmission and the CSI trigger event.

Aspect 14: The method of aspect 13, further comprising: identifying, based at least in part on the time, a first quantization level for a first downlink transmission and a second quantization level for a second downlink transmission that occurs after the first downlink transmission; and determining first CSI for the first downlink transmission using the first quantization level and second CSI for the second downlink transmission using the second quantization level from the accumulated CSI report, wherein the first CSI comprises fewer information bits than the second CSI.

Aspect 15: The method of any of aspects 13 through 14, further comprising: transmitting an indication of a set of quantization levels to the UE; and determining the quantization level for the CSI for each downlink transmission based at least in part on the set of quantization levels.

Aspect 16: The method of aspect 15, further comprising: transmitting a trigger signal identifying a configuration for the accumulated CSI report, wherein the trigger signal comprises the indication of the set of quantization levels.

Aspect 17: The method of any of aspects 13 through 16, further comprising: identifying a resource used for each downlink transmission to the UE, wherein the resource comprises an indication of the quantization level for the downlink transmission.

Aspect 18: The method of any of aspects 13 through 17, further comprising: receiving a quantization level request from the UE indicating quantization levels to use for each downlink transmission in the accumulated CSI report; and transmitting, based at least in part on the quantization level request, a signal identifying a configuration for the accumulated CSI report, wherein the configuration comprises an indication of the quantization levels.

Aspect 19: The method of aspect 18, wherein the quantization level request is received in at least one of an uplink MAC CE or an uplink RRC message, and the signal is transmitted in at least one of a downlink RRC message, a downlink MAC CE or DCI.

Aspect 20: The method of any of aspects 13 through 19, further comprising: determining that a first CSI for a first downlink transmission is a reference CSI; and determining that a second CSI for a second downlink transmission is a differential CSI, wherein the quantization level for the second CSI indicates a difference between the second CSI and the first CSI.

Aspect 21: The method of aspect 20, wherein the first downlink transmission comprises at least one of a latest downlink transmission, or a first downlink transmission, or an intermediate downlink transmission, in time relative to the CSI trigger event.

Aspect 22: The method of any of aspects 13 through 21, further comprising: transmitting an indication of whether the accumulated CSI report comprises a full CSI report or a differential CSI report, wherein the accumulated CSI report and the quantization level of the CSI for each downlink transmission is based at least in part on the indication.

Aspect 23: An apparatus for wireless communication at a UE, comprising a processor; memory coupled with the processor; and instructions stored in the memory and executable by the processor to cause the apparatus to perform a method of any of aspects 1 through 12.

Aspect 24: An apparatus for wireless communication at a UE, comprising at least one means for performing a method of any of aspects 1 through 12.

Aspect 25: A non-transitory computer-readable medium storing code for wireless communication at a UE, the code comprising instructions executable by a processor to perform a method of any of aspects 1 through 12.

Aspect 26: An apparatus for wireless communication at a base station, comprising a processor; memory coupled with the processor; and instructions stored in the memory and executable by the processor to cause the apparatus to perform a method of any of aspects 13 through 22.

Aspect 27: An apparatus for wireless communication at a base station, comprising at least one means for performing a method of any of aspects 13 through 22.

Aspect 28: A non-transitory computer-readable medium storing code for wireless communication at a base station, the code comprising instructions executable by a processor to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory: and
a processor coupled with the memory and configured to:
receive a plurality of downlink transmissions from a base station:
identify a channel state information trigger event; and
transmit an accumulated channel state information report comprising channel state information for each downlink transmission of the plurality of downlink transmissions in accordance with the channel state information trigger event, wherein a quantization level of the channel state information for each downlink transmission in the accumulated channel state information report is based at least in part on a time between the downlink transmission and the channel state information trigger event.

2. The apparatus of claim 1, wherein the processor coupled with the memory is further configured to:
identify, based at least in part on the time, a first quantization level for a first downlink transmission and a second quantization level for a second downlink transmission that occurs after the first downlink transmission: and
indicate first channel state information for the first downlink transmission using the first quantization level and second channel state information for the second downlink transmission using the second quantization level in the accumulated channel state information report, wherein the first channel state information comprises fewer information bits than the second channel state information.

3. The apparatus of claim 1, wherein the processor coupled with the memory is further configured to:
receive an indication of a set of quantization levels from the base station: and
identify the quantization level for the channel state information for each downlink transmission based at least in part on the set of quantization levels.

4. The apparatus of claim 3, wherein the processor coupled with the memory is further configured to:
receive a trigger signal identifying a configuration for the accumulated channel state information report, wherein the trigger signal comprises the indication of the set of quantization levels.

5. The apparatus of claim 1, wherein the processor coupled with the memory is further configured to:
identify a resource used for each downlink transmission from the base station, wherein the resource for each downlink transmission comprises an indication of the quantization level for that downlink transmission.

6. The apparatus of claim 1, wherein the processor coupled with the memory is further configured to:
transmit a quantization level request to the base station indicating quantization levels to use for each downlink transmission in the accumulated channel state information report: and
receive, based at least in part on the quantization level request, a signal identifying a configuration for the accumulated channel state information report, wherein the configuration comprises an indication of the quantization levels.

7. The apparatus of claim 6, wherein the quantization level request is transmitted in at least one of an uplink medium access control (MAC) control element (CE) or an uplink radio resource control (RRC) message, and the signal is received in at least one of a downlink RRC message, a downlink MAC CE or downlink control information (DCI).

8. The apparatus of claim 1, wherein the processor coupled with the memory is further configured to:
identify a first channel state information for a first downlink transmission as a reference channel state information; and
identify a second channel state information for a second downlink transmission as a differential channel state information, wherein the quantization level for the second channel state information indicates a difference between the second channel state information and the first channel state information.

9. The apparatus of claim 8, wherein the first downlink transmission comprises at least one of a latest downlink transmission, or a first downlink transmission, or an intermediate downlink transmission, in time relative to the channel state information trigger event.

10. The apparatus of claim 1, wherein the processor coupled with the memory is further configured to:
receive an indication of whether the accumulated channel state information report comprises a full channel state information report or a differential channel state information report, wherein the accumulated channel state information report and the quantization level of the channel state information for each downlink transmission is based at least in part on the indication.

11. The apparatus of claim 1, wherein the processor coupled with the memory is further configured to:
identify, based at least in part on a configuration for the accumulated channel state information report, a bit-count limit for the accumulated channel state information report:
determine that the channel state information for each downlink transmission in the accumulated channel state information report comprises a set of bits that exceed the bit-count limit; and
discard at least a portion of the channel state information from the accumulated channel state information report based at least in part on the set of bits exceeding the bit-count limit, wherein the discarded portion of the channel state information is associated with an oldest in time downlink transmission relative to the channel state information trigger event.

12. The apparatus of claim 1, wherein the quantization level of the channel state information corresponds to a respective number of bits used to indicate each of one or more parameters included in the channel state information for that downlink transmission.

13. An apparatus for wireless communication at a base station, comprising:
a memory: and
a processor coupled to the memory and configured to:
perform a plurality of downlink transmissions to a user equipment (UE); and
receive, from the UE, an accumulated channel state information report comprising channel state information for each downlink transmission of the plurality of downlink transmissions in accordance with a channel state information trigger event, wherein a quantization level of the channel state information for each downlink transmission in the accumulated channel state information report is based at least in part on a time between the downlink transmission and the channel state information trigger event.

14. The apparatus of claim 13, wherein the processor coupled with the memory is further configured to:
identify, based at least in part on the time, a first quantization level for a first downlink transmission and a second quantization level for a second downlink transmission that occurs after the first downlink transmission; and
determine first channel state information for the first downlink transmission using the first quantization level and second channel state information for the second downlink transmission using the second quantization level from the accumulated channel state information report, wherein the first channel state information comprises fewer information bits than the second channel state information.

15. The apparatus of claim 13, wherein the processor coupled with the memory is further configured to:
transmit an indication of a set of quantization levels to the UE; and
determine the quantization level for the channel state information for each downlink transmission based at least in part on the set of quantization levels.

16. The apparatus of claim 15, wherein the processor coupled with the memory is further configured to:
transmit a trigger signal identifying a configuration for the accumulated channel state information report, wherein the trigger signal comprises the indication of the set of quantization levels.

17. The apparatus of claim 13, wherein the processor coupled with the memory is further configured to:
identify a resource used for each downlink transmission to the UE, wherein the resource comprises an indication of the quantization level for the downlink transmission.

18. The apparatus of claim 13, wherein the processor coupled with the memory is further configured to:
receive a quantization level request from the UE indicating quantization levels to use for each downlink transmission in the accumulated channel state information report: and
transmit, based at least in part on the quantization level request, a signal identifying a configuration for the accumulated channel state information report, wherein the configuration comprises an indication of the quantization levels.

19. The apparatus of claim 18, wherein the quantization level request is received in at least one of an uplink medium access control (MAC) control element (CE) or an uplink radio resource control (RRC) message, and the signal is transmitted in at least one of a downlink RRC message, a downlink MAC CE or downlink control information (DCI).

20. The apparatus of claim 13, wherein the processor coupled with the memory is further configured to:
determine that a first channel state information for a first downlink transmission is a reference channel state information; and
determine that a second channel state information for a second downlink transmission is a differential channel state information, wherein the quantization level for the second channel state information indicates a difference between the second channel state information and the first channel state information.

21. The apparatus of claim 20, wherein the first downlink transmission comprises at least one of a latest downlink transmission, or a first downlink transmission, or an intermediate downlink transmission, in time relative to the channel state information trigger event.

22. The apparatus of claim 13, wherein the processor coupled with the memory is further configured to:
transmit an indication of whether the accumulated channel state information report comprises a full channel state information report or a differential channel state information report, wherein the accumulated channel state information report and the quantization level of the channel state information for each downlink transmission is based at least in part on the indication.

23. A method for wireless communication at a user equipment (UE), comprising:
receiving a plurality of downlink transmissions from a base station:
identifying a channel state information trigger event; and
transmitting an accumulated channel state information report comprising channel state information for each downlink transmission of the plurality of downlink transmissions in accordance with the channel state information trigger event, wherein a quantization level of the channel state information for each downlink transmission in the accumulated channel state information report is based at least in part on a time between the downlink transmission and the channel state information trigger event.

24. The method of claim 23, further comprising:
identifying, based at least in part on the time, a first quantization level for a first downlink transmission and a second quantization level for a second downlink transmission that occurs after the first downlink transmission; and
indicating first channel state information for the first downlink transmission using the first quantization level and second channel state information for the second downlink transmission using the second quantization level in the accumulated channel state information report, wherein the first channel state information comprises fewer information bits than the second channel state information.

25. The method of claim 23, further comprising:
receiving an indication of a set of quantization levels from the base station; and
identifying the quantization level for the channel state information for each downlink transmission based at least in part on the set of quantization levels.

26. The method of claim 25, further comprising:
receiving a trigger signal identifying a configuration for the accumulated channel state information report, wherein the trigger signal comprises the indication of the set of quantization levels.

27. The method of claim 23, further comprising:
identifying a resource used for each downlink transmission from the base station, wherein the resource comprises an indication of the quantization level for the downlink transmission.

28. The method of claim 23, further comprising:
transmitting a quantization level request to the base station indicating quantization levels to use for each downlink transmission in the accumulated channel state information report: and
receiving, based at least in part on the quantization level request, a signal identifying a configuration for the accumulated channel state information report, wherein the configuration comprises an indication of the quantization levels.

29. A method for wireless communication at a base station, comprising:
performing a plurality of downlink transmissions to a user equipment (UE); and
receiving, from the UE, an accumulated channel state information report comprising channel state information for each downlink transmission of the plurality of downlink transmissions in accordance with a channel state information trigger event, wherein a quantization level of the channel state information for each downlink transmission in the accumulated channel state information report is based at least in part on a time between the downlink transmission and the channel state information trigger event.

30. The method of claim 29, further comprising:
identifying, based at least in part on the time, a first quantization level for a first downlink transmission and a second quantization level for a second downlink transmission that occurs after the first downlink transmission; and
determining first channel state information for the first downlink transmission using the first quantization level and second channel state information for the second downlink transmission using the second quantization level from the accumulated channel state information report, wherein the first channel state information comprises fewer information bits than the second channel state information.
